(19) United States
(12) Patent Application Publication
(10) Pub. No.: US 2021/0161618 A1
(43) Pub. Date: Jun. 3, 2021

(54) DENTAL TOOL INDICATOR

(71) Applicant: DENTSPLY SIRONA INC., York, PA (US)

(72) Inventors: Dror SARIG, Misgav (IL); Ami KAMIL, Beerotayim (IL)

(73) Assignee: Dentsply Sirona Inc., York, PA (US)

(21) Appl. No.: 17/044,977

(22) PCT Filed: Apr. 19, 2019
(86) PCT No.: PCT/US2019/028237

§ 371 Date: Oct. 2, 2020

Related U.S. Application Data
(60) Provisional application No. 62/662,348, filed on Apr. 25, 2018.

(51) Int. Cl. A61C 3/02; A61C 1/14; G06K 19/07; G08B 21/18

(52) U.S. Cl. CPC A61C 3/02; A61C 1/14; H04B 10/50; G08B 21/18; A61C 2204/005; G06K 19/0723

(57) ABSTRACT

A dental tool configured for being held by a dental apparatus, the dental tool having at least one material-removing edge in a front portion thereof and a gripping portion in a rear portion thereof, wherein the dental tool comprises a transponder. A system may be provided for receiving data from the transponder and displaying an indication thereof to a user and/or process the data to assist a user in dental activities.

### CROSS-REFERENCE TO RELATED APPLICATIONS

This application claims the benefit of U.S. Provisional Application No. 62/662,348 filed Apr. 25, 2018, entitled “DENTAL TOOL INDICATOR” which is hereby incorporated by reference as if fully set forth herein.

### FIELD OF THE INVENTION

The present application relates generally to a dental tool and, more particularly, but not exclusively, to a dental tool held by a dental apparatus. Also discussed are systems and methods for using the dental tool.

### BACKGROUND OF THE INVENTION

Dental tools, for example, drill bits, are widely used in dentistry. Most of dental tools are held by a dental apparatus that provides rotary motion to the bits. The dental tools have a standard attachment so that a dental apparatus may hold different bits. Some dental tools are held by a dental apparatus that does not provide a rotary motion to the dental tools. Some dental tools, e.g., body try-ins, are held by hand by the dentist.

Some dental tools are used as cutting tools, and they are provided with at least one cutting edge. Some dental tools are used as abrading tools and they may be provided with an abrading surface geometry or coated with a diamond powder.

Most of the dental tools are held by a dental apparatus. The dental apparatus has a head portion provided with gripping means for gripping the dental tool therein. A holding portion, for holding the dental apparatus by a dentist or other professional user, extends rearwardly from the head portion.

U.S. Pat. No. 9,313,558 B1 discloses an assembly comprising a pin or a piece of jewelry and a transponder affixed thereto wherein the transponder is a small, light-triggered transponder.

U.S. Patent Application Publication No. 2003/0062988 A1 discloses an identification system having a light source, an identifiable object and a receiver. The identifiable object has one or more photo-activated microtransponders operatively connected to an article wherein the photo-activated microtransponders are operative to transmit one or more output signals to the receiver in response to one or more light signals from the light source.

### SUMMARY OF THE INVENTION

Existing limitations associated with the foregoing, as well as other limitations, may be overcome by a dental tool held by a dental apparatus as well as systems and methods for using the dental tool.

According to an example embodiment herein a dental tool such as a rotary tool is disclosed with the dental tool having at least one material-removing edge at one end and a gripping portion at another end with the dental tool also including a transponder. The transponder may be attached at a rear end of the dental tool. In an embodiment, the rear portion may be generally cylindrical around a longitudinal axis and includes a cylindrical envelope and a substantially planar end face that is substantially perpendicular to the longitudinal axis with the transponder being attached at the end face of the rear portion. The transponder may also be attached to a cylindrical envelope of the rear portion. In one embodiment, the dental tool is provided with a peripheral ring positioned between the front portion and the rear portion, and the transponder may be located on the peripheral ring. In another embodiment, the transponder may be located within the peripheral ring, and the transponder is an RF transponder. In yet another embodiment, the transponder may be positioned within a recess formed in the dental tool. The transponder may also be covered with a protective substance such as epoxy. Further the transponder may be an optical transponder. In yet another embodiment, the memory of the transponder may store distinct data of the dental tool and a database of a control system of the disclosure may record and update information about the tool such as working-time of the tool. In another embodiment, the memory of the transponder may be such that data about the tool may be written and updated on the memory.

According to an example embodiment herein a dental apparatus for holding a dental tool having a transponder is disclosed. The dental apparatus comprises a head portion having a gripping portion for gripping the dental tool, and the dental apparatus comprises an energy source for energizing the transponder and an energy receiver for receiving a signal from the transponder.

The energy source may be a light source and the energy receiver may be an optical receiver and may be positioned at the head portion of the dental apparatus. In a gripped position of the dental tool, the energy source and the energy receiver may be distanced from the transponder. In an embodiment of the dental apparatus, the dental tool is a rotary tool, the dental apparatus has propulsion means for rotating the dental tool, and in an operative position of the dental tool, the propulsion means are distanced from the transponder.

According to another example embodiment herein a system for identifying a dental tool is disclosed. The system comprises an energy source for energizing a transponder and an energy receiver for receiving a signal from the transponder. The transponder is attached to the dental tool and comprises distinct data of the dental tool, and when the energy source energizes the transponder and receives a signal from the transponder, the system responds to the distinct data of the dental tool. The system comprises procedures that assign a specific dental tool for a specific dentistry operation, and upon receiving the data from the transponder, the system alerts if the dental tool comprising the transponder is a wrong dental tool according to the procedures.

The system may also comprise procedures that assign a given quantity of working-hours for any dental tool for specific dentistry operations, and upon receiving the data from the transponder, the system alerts if the dental tool exceeded the assigned working-hours according to the procedures.

According to another example embodiment herein a method for identifying a dental tool for holding by a dental apparatus is disclosed. The method comprising the steps of providing a dental tool having at least one material-removing edge in a front portion thereof and a gripping portion in a rear portion thereof, and having attached thereto a transponder that comprises distinct data of the dental tool, providing an energy source for energizing the transponder and an energy receiver for receiving a signal from the transponder, and providing a system that upon energizing the transponder and receiving a signal therefrom, modifies, indicates and/or uses the distinct data of the dental tool. In this method the energy source and the energy receiver may be located within the dental apparatus. In the method, the system comprises procedures that assign a specific dental tool for a specific dentistry operation, and upon receiving the data from the transponder, the system alerts if the dental tool comprising the transponder is a wrong dental tool according to the procedures. The system may comprise procedures that assign a given quantity of working-hours for any dental tool for specific dentistry operations, and upon receiving the data from the transponder, the system alerts if the dental tool exceeded the assigned working-hours according to the procedures. Moreover, the method according may be such that the system comprises procedures that assign a specific dental tool for a specific dentistry operation, and upon receiving the data from the transponder, the system may modify or generate an indication of a desired modification in tool settings according to the procedures.

A dental tool comprising at least one ring with at least a portion of a transponder therein is also disclosed.

As will be appreciated by one skilled in the art, some embodiments of the present disclosure may be embodied as a system, method or computer program product. Accordingly, some embodiments of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present disclosure may take the form of a computer program product embodied in one or more computer readable medium(s) having computer readable program code embodied therein. Implementation of the method and/or system of some embodiments of the disclosure may involve performing and/or completing selected tasks manually, automatically, or a combination thereof. Moreover, according to actual instrumentation and equipment of some embodiments of the method and/or system of the disclosure, several selected tasks may be implemented by hardware, by software or by firmware and/or by a combination thereof, e.g., using an operating system.

For example, hardware for performing selected tasks according to some embodiments of the disclosure may be implemented as a chip or a circuit. As software, selected tasks according to some embodiments of the disclosure may be implemented as a plurality of software instructions being executed by a computer using any suitable operating system. In an exemplary embodiment of the disclosure, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the disclosure. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that may communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer, and may not be feasible or practical for performing purely manually, by a human expert. A human expert who wanted to manually perform similar tasks, such as information retrieval, might be expected to use completely different methods, e.g., making use of expert knowledge and/or the pattern recognition capabilities of the human brain.

Further features and advantages, as well as the structure and operation of various embodiments herein, are described in detail below with reference to the accompanying drawings.

### BRIEF DESCRIPTION OF THE DRAWINGS

Some embodiments of the disclosure are herein described, by way of example only, with reference to the accompanying drawings. With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

FIG. 1 is a side view of a dental apparatus according to an embodiment herein;

FIG. 2 is a side cross-sectional schematic view of a dental apparatus holding a dental tool according to some embodiments of the present invention;

FIG. 3 is an enlargement of the head portion of the dental apparatus and the dental tool of FIG. 2;

FIG. 4 is a sectional view of the energy source and energy receiver taken along line IV-IV in FIG. 3;

FIG. 5 is a perspective view of a dental tool according to some embodiments of the present invention;

FIG. 5a is an enlarged perspective view of the rear end of the dental tool of FIG. 5;

FIG. 5b is a cross-sectional view of the transponder and the recess of FIG. 5a taken in a plane passing through the longitudinal axis A;

FIG. 6 is a rear end view of the dental tool of FIG. 5;

FIG. 7 is a partial sectional side view of the peripheral ring of the dental tool of FIG. 5;

FIG. 8 is a side cross-sectional schematic view of an embodiment of a dental tool and a dental apparatus according to some embodiments of the present invention;

FIG. 9 is a side view of another embodiment of a dental tool according to the present invention;

FIG. 10 is a side cross-sectional schematic view of an external add-on reader according to another embodiment of the present invention;

FIG. 11 is a flowchart of some embodiments of a method for utilizing a dental tool according to the present invention;

FIG. 12 is a side cross-sectional schematic view of a kit of dental tools according to some embodiments of the present invention;

FIG. 13 is a general representation of a system for identifying a dental tool according to some embodiments of the present invention;

FIG. 14 is a flowchart of a process used by a dentist having an apparatus that is equipped with a reader for identifying that a correct tool is used during a specific process, according to some embodiments of the present invention;

FIG. 15 is a flowchart of a process used by a dentist for making sure that a worn-out tool is not used, according to some embodiments of the present invention;

FIG. 16 is a flowchart of a process used by a dentist having an apparatus not equipped with a reader for identifying a dental tool, according to some embodiments of the present invention;

FIG. 17 is a partial sectional view of a dental tool according to some embodiments of the present invention wherein a peripheral ring serves both as an ID and as an integral part of a dental tool:

FIG. 18 is a partial sectional view of a dental tool according to some embodiments of the present invention wherein the peripheral ring is formed separately (e.g., removably attached) from the shank of the dental tool;

FIG. 19 is a partial sectional view of a dental tool with an add-on peripheral ring to form a dental tool wherein there is no positioning element, according to some embodiments of the present invention;

FIG. 20 is a partial sectional view of a dental tool within a dental apparatus with a transponder attached at a rear end of the dental tool and a protective layer covering the transponder.

FIG. 21 is a diagram of a computer system according to another embodiment of the present invention.

Different ones of the Figures may have at least some reference numerals that are the same in order to identify the same components, although a detailed description of each such component may not be provided below with respect to each Figure.

### DETAILED DESCRIPTION OF THE INVENTION

The present invention, in some embodiments thereof, relates to a dental tool and, more particularly, but not exclusively, to a dental tool including a machine-readable identifier, that is for example, RF readable or optically readable.

### Dental Tool and Dental Apparatus

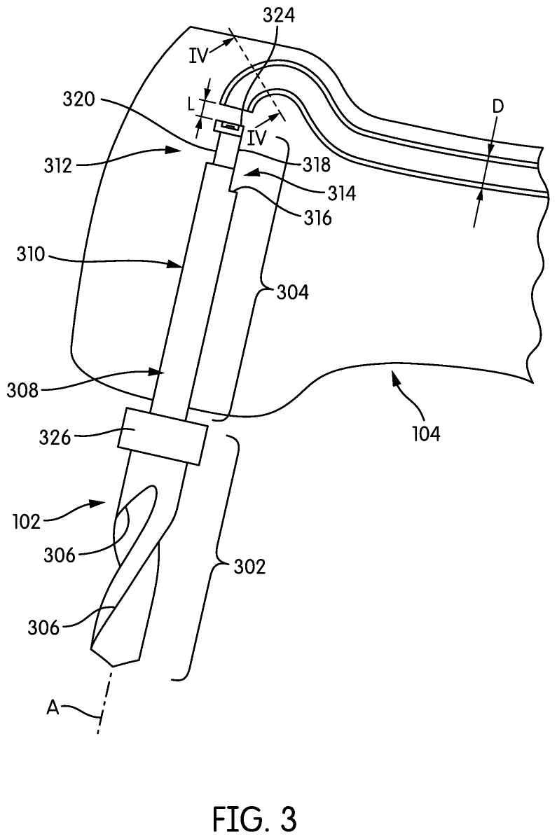

An aspect of some embodiments of the disclosure relates to a dental tool that may be provided with a machine-readable storage element, for example, a transponder. The transponder may include distinct data regarding the dental tool, for example, its identification. In some exemplary embodiments of the disclosure, a front portion of the dental tool serves as an active portion, e.g., it contains at least one material removing edge, such as a drill bit, or, has a reference measure, for example, diameter, for a body try-in. A rear portion of the dental tool optionally serves as a gripping portion, where it may be gripped by a dental apparatus or by hand. In some exemplary embodiments of the disclosure, an identifier may be located at the handle portion of the tool (e.g., at a rear end of the tool) so that it may be read by the dental apparatus and/or an add-on thereon (FIG. 3).

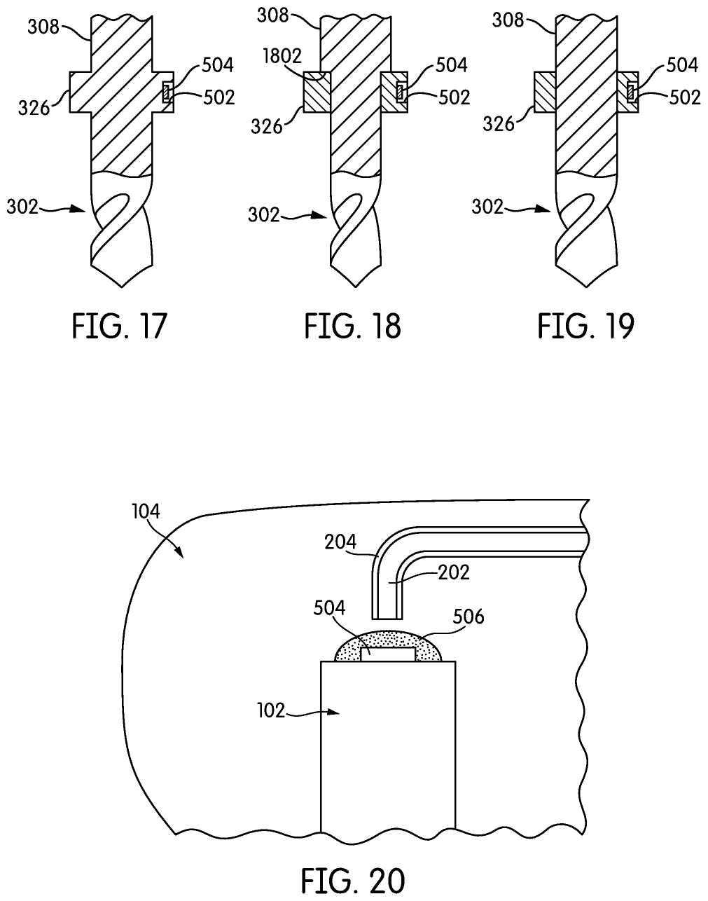

In some exemplary embodiments of the disclosure, the identifier is an optical transponder, optionally sized to fit in a recess in the tool. In some exemplary embodiments of the disclosure, the identifier may be mounted on a ring surrounding part of a shaft of the tool e.g. (FIGS. 17-19).

A particular advantage of an optical transponder over some RF transponders, in accordance with some embodiments of the disclosure is that an optical receiver and/or transmitter may be smaller than a typical dimension of a tool and therefore may fit (either partially or substantially completely) within a recess of the tool while not interfering with the intended use of the tool. While the tool is held by the dental apparatus, contactless coupling between the transponder and a reader may be provided. Moreover, a reader may be included and set up to read/monitor multiple tools simultaneously or individually. In one preferred embodiment, the reader may be set up to avoid reading multiple tools simultaneously, for example, set up to only read the inserted tool. This may be achieved by determining a required communication distance between the reader and the transponder.

In some exemplary embodiments of the disclosure, some or all of the data in the tool identification may be written on the transponder prior to its use, e.g., name of dental tool, type of dental tool, tool's drilling diameter, tool's working speed and/or tool's try-in diameter. Some or all of the data may be written in a database of a control system during and/or after use of the tool, e.g., working hours. In some embodiments, the transponder is attached to the dental tool at a position that enables its reading without disturbing the gripping of the dental tool by the dental apparatus.

In some embodiments, the transponder may be attached within a recess formed on the dental tool. In some embodiments, a portion of or the entire transponder may be covered with a protective substance, for example, one or more epoxies. In some embodiments, the transponder may be pre-covered with a protective substance and is not attached within a recess, but rather mounted on the tool

In some embodiments, the transponder may be attached to a recess that is formed on the rear face of the dental tool, and, the dental apparatus may be provided with a reader that is located at a head portion of the dental apparatus. Optionally, when the dental tool is gripped by the dental apparatus, the reader is distanced within an operating distance from the transponder. In some embodiments, the transponder constitutes an optical transponder and the reader comprises an optical reader which may include a light source and a light sensor. In some exemplary embodiments of the present invention, a separation is maintained between the transponder and the reader to allow free rotation of the dental tool with respect to the dental apparatus, while providing sufficiently close distance for the reader to read the transponder. In some embodiments, the operating distance is between 3 and 0.1 mm, for example, about 1 mm. In an embodiment, the reader is attached as an additional unit to an existing handpiece. In another embodiment, the reader is produced with or embedded in the handpiece (FIG. 2).

In some exemplary embodiments of the present invention, the distinct data of the transponder may be analyzed to detect a correspondence between usage instructions and actual usage. Optionally or alternatively, the data is used to set up or provide a suggestion for manual set up (e.g., preferred set-up) of a motorized tool such as a drill. In one example, the data is transferred, through the reader, to a control system. The control system analyses the data. The data is analyzed, and compared to pre-set dentistry procedures. In a case of discrepancy between the analyzed data and the pre-set data, the control system provides an alert. Reasons for an alert may be, e.g., (a) using a wrong tool type for the specific use (e.g., dental procedure or one or more steps of a dental procedure, (b) using a wrong speed for the specific use, (c) using a wrong tool during a specific drilling sequence. The alert may include, but is not limited to, some or all of the following: a visual warning on a monitor screen, a warning light, an audio signal through a buzzer or a speaker, and/or a tactile warning such as a vibration.

In some embodiments, a transponder of the tool may include a memory with a tool identification number which correlates to one or more of specific data of the tool (for example working/usage hours), usage instructions, machine settings, in a database of the control system of the disclosure. In an embodiment, the specific data of the tool may be updated.

The database may record, for example, the number of working-hours of the dental tool having that transponder. When the system analyses the data from the transponder, it initiates an alert if the dental tool has exceeded the predetermined/preferred “maximum” amount of working/operating-hours designated to that tool according to the type of procedure(s). In this specific example, the alert signifies that the dental tool has been excessively used (e.g., is worn out) and should be replaced by a new tool. The database is not limited to record working-hours only, and other data may be recorded as well or instead, e.g., the type of procedure in which the dental tool is involved, the amount of force being applied on/to the tool during the procedure, the speed of the tool during the procedure, the amount of torque being applied on/to the tool during the procedure, the temperature of the tool during the procedure).

In some embodiments, the dental apparatus does not include a reader. Optionally, prior to inserting the dental tool into the dental apparatus, the dental tool is inserted into or brought into proximity of a reader device connected to the system. The device may be, for example, portable, temporarily attached to the system, fixedly attached to the system, and/or being an integral part of the system. The device may communicate with the system by wire or by wireless transmission such as Bluetooth. In some exemplary embodiments of the invention, the reader device may include a reader, for example, having a light source and an optical reader that, upon operation, may transfer into the system the distinct data of the dental tool, for example. Herein a small microtransponder tag such as a p-Chip® may be used as the transponder. The microtransponder tag may carry a unique serial number (ID) in its memory and/or include photocells that, when illuminated by light from the reader, provide power and synchronization signals for the microtransponder tag's electronic circuits. Additionally, the microtransponder tag may include an on-chip antenna that transmits its ID to the reader when stimulated by, for example, pulsed, laser light or a single frequency LED.

In some cases, the transponder may not be attached directly to the dental tool. In these cases, the transponder is attached to (removably secured or fixedly secured to), or embedded into (either partially embedded or completely embedded), e.g., a ring, that is later on fixed (secured) to the dental tool.

The transponder may not be an optical transponder. In some cases, such as, e.g., when the transponder is embedded within a ring, the transponder is an RF transponder and may use the circumferential dimension of the ring to support a longer antenna than possible on a tool shaft.

In some cases, there are dental tools that may be used manually (e.g., are not held by a dental apparatus), such as body try-ins that are used during implanting procedures. In these cases, the dental tool may be inserted into or brought near a reader device connected to the system for reading the distinct data of the dental tool. Such reader device may be a stand-alone device, or may be a part of the system. In further embodiments, the transponder may be similarly attached to or integrated with other tools such as dental files, dental implants, dental burs, dental drills, obturators and the like.

An aspect of some embodiments of the present invention relates to managing tool usage based on data stored on dental tools. In one example, incorrect tool usage is identified based on a mismatch between data read form the tools and the expected data (e.g., mismatch of tool type identification with expected tool sequence). An alert may be generated to a user.

In some exemplary embodiments of the present invention, tool settings are set based on tool identification and/or tool sequence.

In some exemplary embodiments of the present invention, tool settings may be modified based on manual tool selections. For example, an RPM and/or time limit of a tool may be recommended or automatically set by a dental system based on the previous tool and/or tools used and/or by an extent of their use.

A dental tool may be used to remove or otherwise modify dental tissue and this may be irreversible A potential advantage of transponders for dental tools may be that the correct settings for using a tool and/or the correct order of steps in using multiple tools may be monitored efficiently according to methods described herein to reduce incorrect dental modification.

Before explaining at least one embodiment of the disclosure in detail, it is to be understood that the disclosure is not necessarily limited in its application to the details of construction and the arrangement of the components and/or methods set forth in the following description and/or illustrated in the drawings and/or the Examples. The disclosure is capable of other embodiments or of being practiced or carried out in various ways.

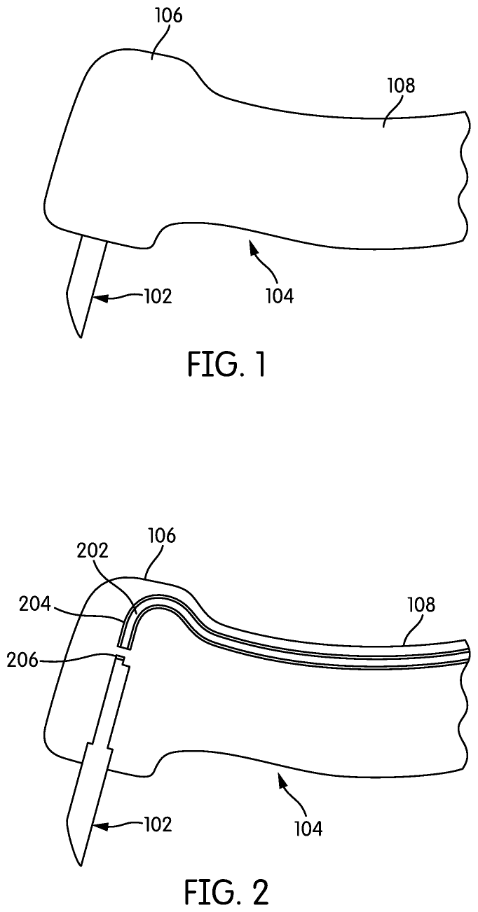

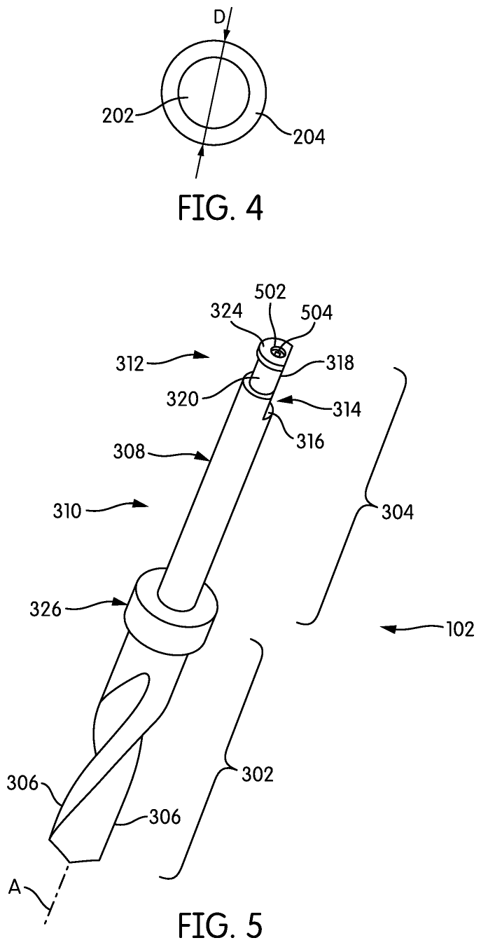

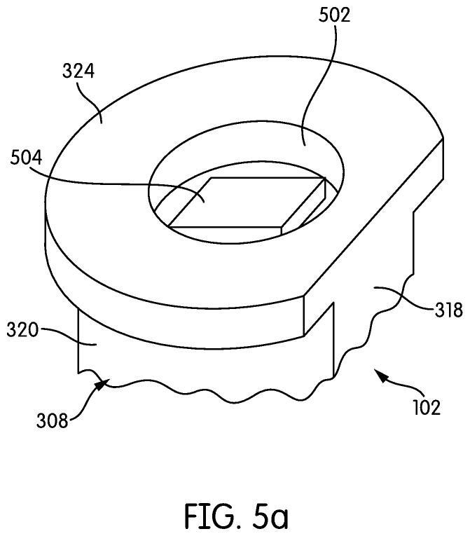

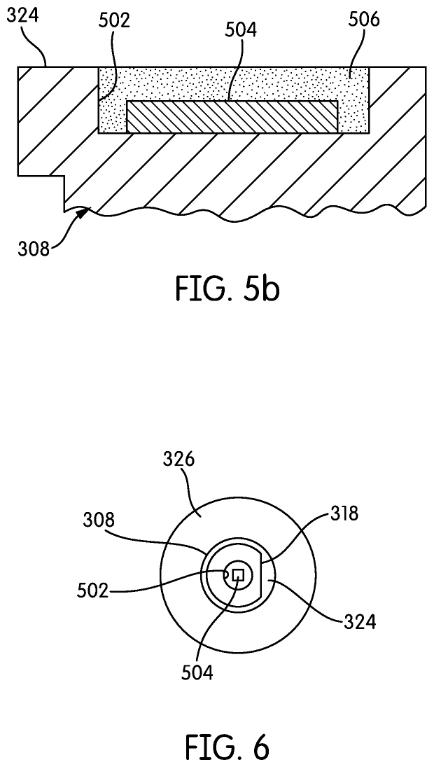

For purposes of better understanding some embodiments of the present disclosure, as illustrated in FIGS. 1-20 of the drawings, reference is first made to the construction and operation of a plain dental tool as shown in FIG. 1 which illustrates a dental tool 102 that is held by a dental apparatus 104. The dental apparatus 104 has a head portion 106 provided with gripping means for gripping the dental tool 102 therein. A holding portion 108, for holding the dental apparatus 104 by a dentist or other professional user, extends rearwardly from the head portion 106.

FIG. 2 is a side cross-sectional schematic view of a dental apparatus 104 holding a dental tool 102 according to some embodiments of the present disclosure. According to some embodiments of the present disclosure, the dental apparatus 104 according to the present disclosure includes, a transponder reader for reading a transponder that is attached to the dental tool. According to some embodiments, the dental apparatus 104 includes a light source 202 and an optical reader 204 that extend through the holding portion (e.g., handpiece body portion) 108 and ends in the head portion 106 at a location opposite to a rear end 206 of the dental tool 102, on which, according to some embodiments, the transponder may be attached. In one specific embodiment herein, the optical reader 204 is an RF detector.

According to some embodiments, the light source 202 and the optical reader 204 may be laid (positioned/located) within a single conductor or channel, wherein the light source 202 passes in the center and is peripherally bounded by the optical reader 204.

In some exemplary embodiments of the disclosure, the installation of the light source 202 and the optical reader 204 within the dental apparatus 104 may be provided such that there is little or substantially no external modifications to the dental apparatus 104. However, if necessary in some cases, the dental apparatus 104 may be altered to enable adequate installation of the light source 202 and the optical reader 204 within the dental apparatus 104.

FIG. 3 is an enlargement of the dental tool 102 secured within the head portion 106 of the dental apparatus 104, in accordance with some embodiments of the present invention. The dental tool 102 is generally divided into a front portion (proximal portion) 302, and, a rear portion (distal portion) 304 that extends rearwardly from the front portion 302. As shown in FIG. 3, when the dental tool 102 is gripped within the dental apparatus 104, the rear portion 304 of the dental tool 102 may be substantially located within the head portion 106 of the dental apparatus 104, and, the front portion 302 of the dental tool 102 may extend away from the head portion 106 of the dental apparatus 104 to a substantially external location, though not required.

Reference is now made to FIGS. 3-6. The front portion 302 of the dental tool 102 is the “active” portion (e.g., working portion). i.e., the portion that performs drilling, milling abrading, and the like operations. In the embodiment shown, the front portion 302 constitutes a drill having cutting edges 306 for removing material during dental operations. Thus, in that sense, the front portion 302 of the dental tool 102 has at least one material removing edge. In some embodiments, the active edge does not remove material or, at least, is not configured to cut bone.

According to some embodiments of the present invention, the rear portion 304 may be generally formed from an elongated shank 308. The shank 308 has a gripping portion 310, in a forward direction thereof, e.g., toward the front portion 302 of the dental tool 102, and, an abutment portion 312, rearward to the gripping portion 310. The gripping portion 102 may be of any shape or size such as being generally cylindrical or otherwise.

In some exemplary embodiments of the present invention, the abutment portion 312 may include a cutaway 314 having a rearwardly directed rear stopper surface 316 that is directed substantially perpendicularly to a longitudinal axis A of the dental tool 102, and, a torque transferring surface 318 that is directed substantially parallel to the longitudinal axis A.

The abutment portion 312 may further include, opposite to the cutaway 314, a locking indentation 320, for locking the dental tool 102 to the dental apparatus 104 by a locking lever (not shown). The abutment portion 312 ends, optionally, in a rearwardmost end thereof, with a rear end face 324 that is substantially perpendicular to the longitudinal axis A.

According to some embodiments, a recess 502 may be formed in the rear end face 324. A transponder 504 may be releasably of fixedly attached to and/or positioned within the recess 502. In some embodiments, the transponder 504 may be releasably or fixedly attached to a surface (e.g., bottom surface) of the recess 502 and partially or substantially covered with a protective substance 506, that may be optionally transparent and/or autoclavable, for protecting the transponder 504 during cleaning processes of the dental tool 102. The protective substance 506 may be any material that enables mechanical protection of the transponder 504, while enabling communication with the transponder 504. In some embodiments, the protective substance is epoxy or otherwise similar protective coating.

When the dental tool 102 is gripped within the dental apparatus 104, the light source 202 and the optical reader 204 are distanced an operating distance L from the transponder 504. According to some embodiments, the operating distance L may be from about 0.05 to about 3 mm (e.g., about 1 mm).

Typically, the light source 202 and the optical receiver 204 may be combined together within a single conduit having a conduit outer diameter D. According to some embodiments, the conduit diameter D may be about 1-10 mm, for example, about 4-5 mm.

In some embodiments, the dental tool 102 may be provided with a peripheral ring 326 that may be located between the front portion 302 of the dental tool 102 and the rear portion 304 of the dental tool 102. Practically, the peripheral ring 326 may be diametrically larger than the front portion 302 and the rear portion 304. When using the dental tool 102, e.g., for a drilling operation on a bone tissue during an implant surgical operation, the peripheral ring 326 may serve as a built-in stopper, that may prevent over-drilling by the dental tool 102, and/or, in some cases, may set the drilling depth and/or be used for attachment to handle. In some embodiments, the peripheral ring may be replaced and/or enhanced by a transponder add-on which acts as the peripheral ring.

Reference is now made to the following embodiments, which together with the above descriptions illustrate some embodiments of the present invention in a non-limiting fashion. According to some embodiments, the peripheral ring 326 may be integrally formed with the dental tool, as shown in FIG. 17. A transponder 504 may be attached to a recess 502 formed in the periphery of the peripheral ring 326.

FIG. 18 shows an embodiment wherein the peripheral ring 326 may be formed separately from the shank 308 of the dental tool. In this case, the shank 308 may be formed with a positioning element 1802. In this embodiment the positioning element 1802 is facing forwardly, toward the front portion 302 of the dental tool. However, the positioning element 1802 may face to the opposite direction or other direction, depending on production needs, such as differences between the diameter of the front portion 302 and the diameter of the shank 308.

As mentioned, the peripheral ring 326, may be optionally produced separately from the dental tool, and a transponder 504 may be attached to a recess 502 formed in the ring. At this stage, the peripheral ring 326 may be inserted over the front portion 302 of the dental tool and slides rearwardly until it abuts against the positioning element 1802. Finally, the peripheral ring 326 may be connected to the dental tool by methods known in the art, e.g., shrink fit, brazing, and the like.

FIG. 19 shows an embodiment wherein the peripheral ring 326 may be formed separately from the dental tool. A transponder 504 may be attached to a recess 502 formed in the ring. At this stage, the peripheral ring 326 may be inserted onto the dental tool until placed in the desired position, and may be connected/attached to the dental tool by methods known in the art, e.g., shrink fit, brazing, and the like.

The transponder may not have to be attached externally to the dental tool. Alternatively, the transponder may be embedded within the peripheral ring. In that case, the communication with the transponder may be through wireless means (e.g., radio or ultrasonic radiation) other than optical.

The transponder may not have to be an optical transponder and other types of transponders as known in the art may be used, e.g., radio, ultrasonic and/or magnetic. The selection may depend on the intended use, gripping method, peripheral clearance and/or other design considerations. This may be an advantage of the transponder that it may be embedded in a ring formed of non-transparent material.

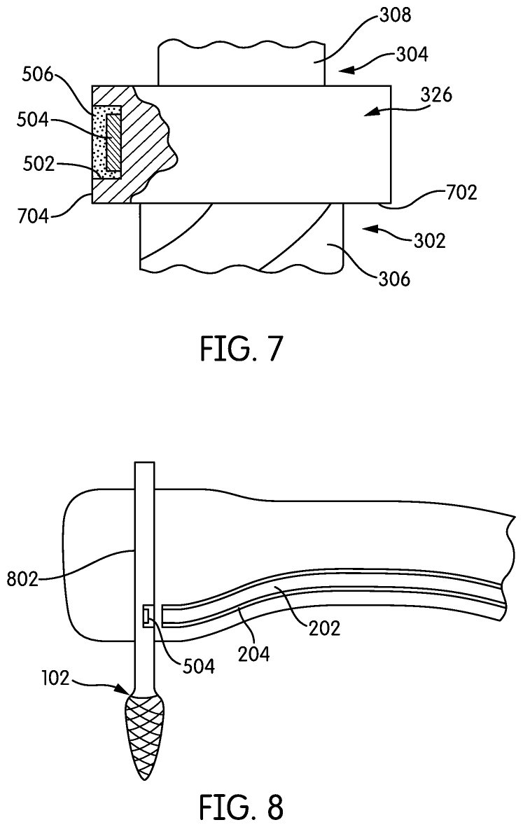

FIG. 7 shows another embodiment of the present invention wherein the transponder 504 may be located on and/or in the peripheral ring 326. For example, the transponder may be, one or some of the following: (a) externally attached to the peripheral ring. (b) internally attached to the peripheral ring. (c) embedded within the peripheral ring, partially or as a whole. As shown, the peripheral ring 326 may be located between the front portion 302 of the dental tool 102 and the rear portion 304 of the dental tool 102. A forwardly directed face of the peripheral ring 326 may serve as a built-in stopper 702.

The peripheral ring 326 may be formed, but not limited to, in one of the following manners: (i) The peripheral ring 326 may be integrally formed with the dental tool 102 during its manufacturing process. In which case, the diameter of the front portion 302 of the dental tool 102 may be larger, smaller or equal to the diameter of the rear portion 304 of the dental tool 102. (ii) The peripheral ring 326 and the dental tool 102 may be separately formed, but, pre-designed to fit together. Then, the peripheral ring 326 may be assembled onto the dental tool 102, as an add-on, and joined therewith by methods known in the art, e.g., shrink fit, brazing, and the like. For practical reasons, it may be beneficial to the assembling process when either of the front portion 302 or the rear portion 304 of the dental tool 102 have smaller diameter, thus, forming a step therebetween, and the peripheral ring 326 is inserted onto the dental tool 102 until abutted with the step. (iii) The peripheral ring 326 and the dental tool may be separately formed. In this case, the dental tool may be a common dental tool used in the field of dentistry, and, the peripheral ring 326 is assembled thereon, as an add-on, by methods known in the art, e.g., shrink fit, brazing and the like, thus forming a dental tool 102 according to the present disclosure.

As shown in FIG. 7, the peripheral ring 326 may be provided with a recess 502 in a peripheral face 704 thereof. A transponder 504 may be attached to the bottom of the recess 502 and may be covered with a protective substance 506 such as epoxy and/or otherwise. A reader 204 may directly face the transponder for communication wherein the communication takes place when the transponder faces the reader at a predetermined rotational angle along a plane perpendicular to the longitudinal axis A of the dental tool 102.

In some embodiments, the transponder may form the entire ring. Optionally or alternatively, the transponder may also be an RF transponder, with an antenna extending circumferentially, for example, at least ½ a circumference.

A potential advantage of locating the transponder 504 within the peripheral ring 326, when the peripheral ring 326 is separately formed from the dental tool, may be that any common dental tool used in the art may be provided with a transponder 504 without a necessity to amend the dental tool.

The transponder 504 may not be located at the rear end face 324 of the dental tool 102. For some embodiments, as shown, e.g., in FIG. 8, the transponder 504 may be located within a recess formed at the shank peripheral face 802 and is optionally covered with a protective substance 506. Optionally, this means that the transponder faces a reader only part of the time. Alternatively, the reader may include a light collection element circumferentially surrounding the shank, so as to receive light form any and/or several shank rotational positions.

In some embodiments, the rear-end of the tool may partially extend out of the dental apparatus. In some embodiments, the reader may enclose such an extending rear end. In some embodiments, as shown, for example, in FIG. 20, the transponder 504 may be attached on the rear end face 324 of the dental tool, covered with a protective substance 506, and/or may not positioned within a recess.

In some embodiments, for this and/or other transponder locations, the transponder may be press fit or may be snap fit in a recess. Optionally or alternatively, the transponder may be laid on the surface and attached thereon, for example, using an adhesive.

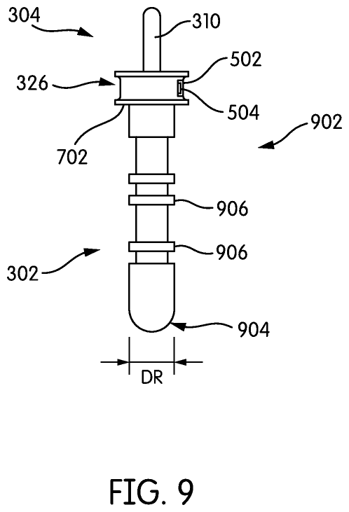

FIG. 9 shows an embodiment of another dental tool according to the present invention in a form of a body try-in 902. The body try-in 902 may include, at a front portion 302 thereof, a rounded leading end 904 having a diameter of a reference measure DR, and, a plurality of spaced apart leading rings 906 having the same reference measure DR.

The body try-in 902 may not be held by a dental apparatus, but, may be manually held at a gripping portion 310 at a rear portion 304 of the body try-in 902.

A peripheral ring 326, having a built-in stopper 702 in a forwardly directed face thereof, may be located between the front portion 302 and the rear portion 304. A transponder 504 having distinct data of the body try-in 902 may be located within a recess 502 formed in the peripheral ring 326 and covered with a protective substance.

Such a type of body try-in 902 may be optionally used, e.g., during surgical implant procedures, when it is necessary to verify the diameter of a hole drilled into the bone tissue after drilling by a different diameter drill.

Optionally, the body try-in 902 may be read by a standalone reader, rather than a holding dental apparatus.

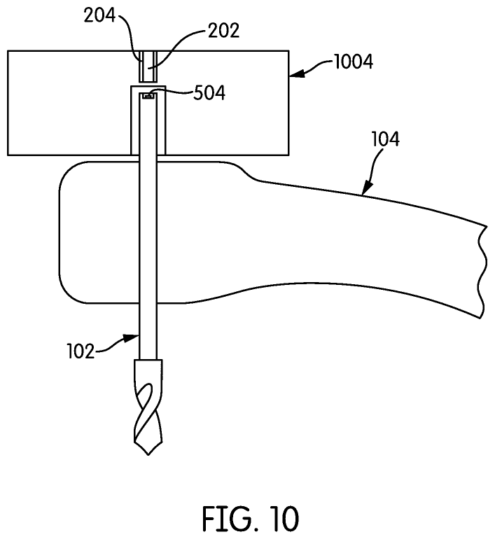

FIG. 10 schematically represents embodiments where the light source 202 and/or the optical reader 204 may not be located within the dental apparatus 104 as shown in FIGS. 2 and 3. Such cases may occur, e.g., when the dental tool is not held by the dental apparatus, as is the case with the body try-in 902 in FIG. 9, or, when the dental tool may be held by the dental apparatus but it is easier to read the distinct data of the transponder by a device that is located externally to the dental apparatus.

Optionally, as shown in FIG. 10, a dental tool 102 may be held by a dental apparatus 104. The dental tool may have a free rear portion 1002 that extends outwardly and beyond the dental apparatus 104. A transponder 504 may be attached to the dental tool 102 at a free rear portion. The light source 202 and the optical reader 204 may be located within a reading device 1004 that may be separately formed from the dental apparatus 104 and may be connected to a control system 1302 as will be explained with regard to FIG. 13.

### Dental System and Dental Method

As shown in FIG. 13, a system 1304 for identifying a dental tool, which will hereinafter be called “system”, comprises a control system 1302 that may be set according to various surgical implant operating procedures. Optionally, system 1302 may include two components, a (optionally standard) dental tool controller and a controller for communication with the transponder and processing of data to and/or form the transponder. Such procedures may include the use of a variety of tools that are arranged within a surgical kit. Such tools are, e.g., but not limited to, depth guides, marking drills, pilot drills, twist drills, body try-ins, insertion tools and accessories. Typically, not all the tools may be used for each procedure and the order and subset of the tools to use follow guidelines, as may settings (e.g., speed, pulse form, duration of use and/or safety settings) for such tools.

It is believed that during a surgical operation, it may often be important to use the right tool at the right time, e.g., a large diameter drill may be used only after a smaller diameter drill has been used and the right diameter has been verified by the correct body try-in.

The light source 202 and the optical reader 204, that are located within the dental apparatus 104 as shown in FIGS. 2-4, may be connected to the control system 1302. Likewise, the light source 202 and the optical reader 204 that are located within the reading device 1004 may also be connected to the control system 1302. The system 1304 optionally may include visual accessories like a warning light 1306 and/or a monitor screen 1308, and/or audio accessories such as a speaker 1310, that may all be connected to the control system 1302.

In some exemplary embodiments of the present invention, the control system 1302 may operate by at least one power source. The power source may be an AC power (for example 120V/60 Hz), or, an internal power. (for example, from batteries) when the control system 1302 is not self-powered. When the system 1304 is ready to be operated, the dentist or its assistant turns-on the control system 1302. In this position, the control system 1302 may operate in one of the following manners: (i) The light source 202 and the optical reader 204 may be continuously operable, and, when a transponder 504 is introduced in front of the light source 202 the data within the transponder may be read by the optical reader 204 and transferred to the control system 1302. (ii) The light source 202 and the optical reader 204 may be operable only when they come in the vicinity of a transponder 504. The detection of a transponder 504, whether within the dental apparatus 104 or within the reading device 1004, may be done by a sensor, for example, a mechanical sensor or an electronic sensor.

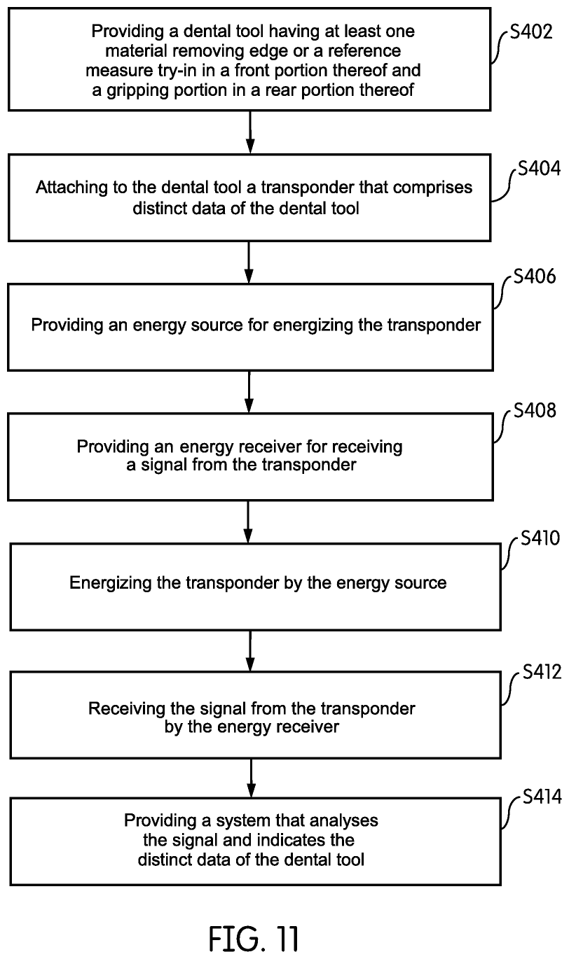

In some exemplary embodiments of the present invention, when a dental tool 102 is gripped by the dental apparatus 104, or, when a dental tool 102 is positioned opposite the reading device 1004, by the dentist or other treating professional, the control system 1302 may operate the relevant light source 202 and the optical reader 204 and thus may receive the distinct data of the dental tool 102 in use. In an example embodiment herein, a method is provided comprising the steps as shown in FIG. 11. The method includes providing a dental tool 102 having at least one material removing edge or a reference measure try-min a front portion thereof and a gripping portion in a rear portion thereof an in Step S402. A transponder 504 may be attached to the dental tool 102 as in Step S404. An energy source such as a light source 202 may be provided in Step S406 and an energy receiver such as an optical reader 204 may be provided in Step S408. The control system 1302 may control the energy source to energize the transponder in Step S410, and may also control an energy receiver to receive signals from the transponder 504 as in Step S412. The control system 1302 may then analyze the received signals and may indicate the distinct data of the dental tool 102 as in Step S414.

The control system 1302 may provide output data, according to pre-set data of specific dentistry procedures, and, it may receive input data, typically through the monitor screen 1308, by the doctor who may decide about different settings of the system 1304 according to his needs, e.g., using a different dental tool than a pre-set dental tool for a given operation at a given moment. Matching data may be found on or indicated on the transponder, for example, the data being indexed to tool identification.

In some exemplary embodiments of the present invention, the control system 1302 may function, through a user interface, in one or more of the following manners: (a) as an input receiving channel, wherein the input may be received and analyzed according to pre-set procedures and parameters, (b) as a tool operation channel, wherein the operator of the system 1304 may set the operation parameters for the active dental tool, e.g., rotation speed, working time, and the like.

During a dental operation, the doctor and/or the doctor's assistant may decide about a dental tool that they want to use. The chosen dental tool is picked up, from a working table, storage casing and the like, and is placed such that its data may be readable. In that manner, the doctor may verify that the tool in hand is actually the one that was chosen, and, that its characteristics comply with the intended use that is set by the doctor.

In some operations, according to pre-set data at the control system 1302 regarding the specific procedure in use, the control system 1302 may analyze if the dental tool 102 to be used is the correct tool or not. Thus, if the dental tool 102 is the correct one, the system positively acknowledges it by a first indicia such as verifying sound, green light, positive display, etc. However, if some set-ups (e.g., set by user or based on a reading of data from the transponder) are incorrect, e.g., (a) using a wrong tool type for the specific use, (b) using a wrong speed for the specific use, (c) using a wrong tool during a specific drilling sequence, (d) using a worn-out tool, then, the system optionally gives a second indicia such as warning, for example, both audio and visual, as set by the system's operator, i.e., the dentist or the assistant, and a wrong use of a dental tool is successfully prevented. The control system 1302 may react differently, i.e., give different output, according to different inputs and different set-ups of the control system 1302.

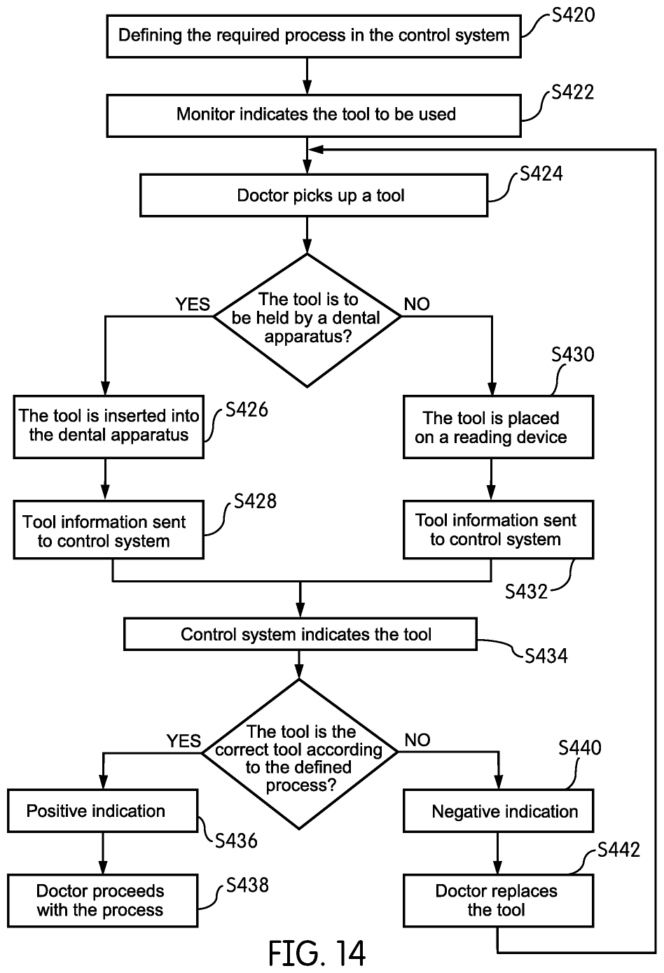

FIG. 14 is a flowchart of a process that may be used by a dentist having an apparatus already equipped with a reader 204 for identifying that a correct tool is used during a specific process, according to some embodiments of the present invention. A treatment process may be defined in the control system 1302 as show in Step S420. The monitor may then shows which tool should be used, Step S422. After picking up the dental tool, Step S424, the dentist checks to determine if the tool is to be held by a dental apparatus 104. In some cases, where the tool is to be held by the dental apparatus 104, the dental tool is inserted into the dental apparatus 104 as shown in Step S426. The dental apparatus 104 may include a light source 202 and an optical reader 204 that, upon operation, may transfer to the control system 1302 the distinct data of the dental tool 102 as in Step S428. The control system 1302 may indicate the dental tool 102 in Step S434 and if found to be the correct tool by the control system 1302, the dental treatment proceeds, Steps S436, S438. However if found to be the wrong tool, the tool should be replaced and the process is repeated with the new tool, Steps S440, S442.

In other cases, where the dental apparatus 104 may be equipped with a reader 204 but the dental tool 102 may not be held by a dental apparatus 104, the dental tool 102 may be inserted into the reading device 1004, as in Step S430, that may be connected to the control system 1302. The reading device 1004 may include, as described above, a light source 202 and an optical reader 204 that, upon operation, transfer to the control system 1302 the distinct data of the dental tool 102 in Step S432, similar to the manner described above. The control system 1302 may indicate the dental tool 102 in Step S434 and upon identifying that the dental tool 102 is the correct tool, the dental treatment may proceed Steps S436, S438. However if found to be the wrong tool, the tool should be replaced and the process is repeated with the new tool, Steps S440, S442

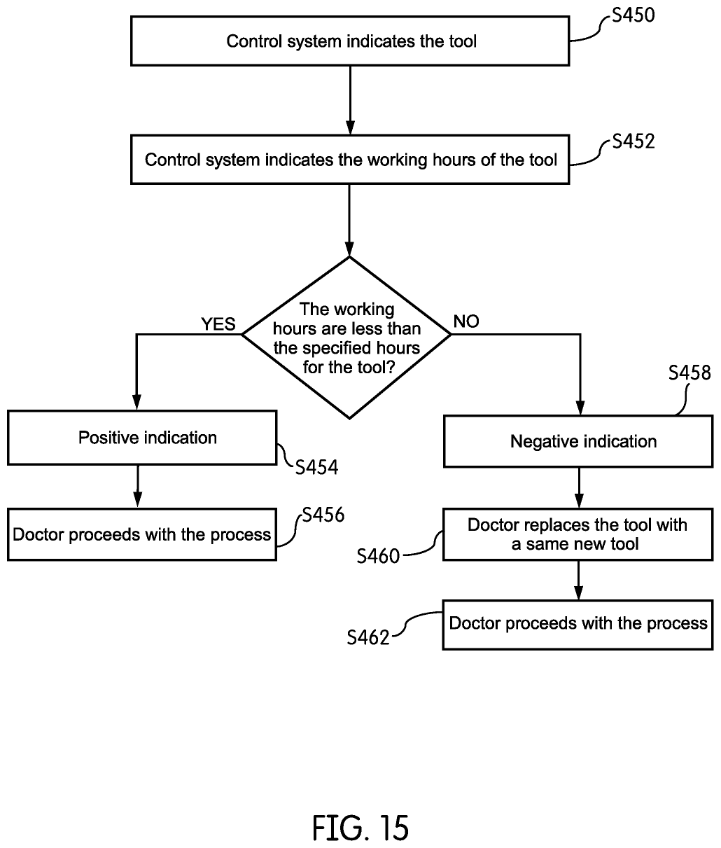

In another example embodiment herein, the control system 1302 may check that a dental tool 102 is worn out and therefore may not suitable for a specific dental treatment. Herein, FIG. 15 shows that after reading data from the dental tool 102, the control system 1302 may indicate the tool in Step S450. The working hours of the dental tool may also be indicated in Step 452. If the working hours are less than a predetermined or specified/preferred working hours, Step S454, the doctor may proceed with dental treatment, Step S456. However if the predetermined working hours have been exceeded, Step S458, the doctor should replace the dental tool 102 with a new tool (preferably the same tool or a similar tool, Step S460 and proceeds with the dental treatment, Step S462.

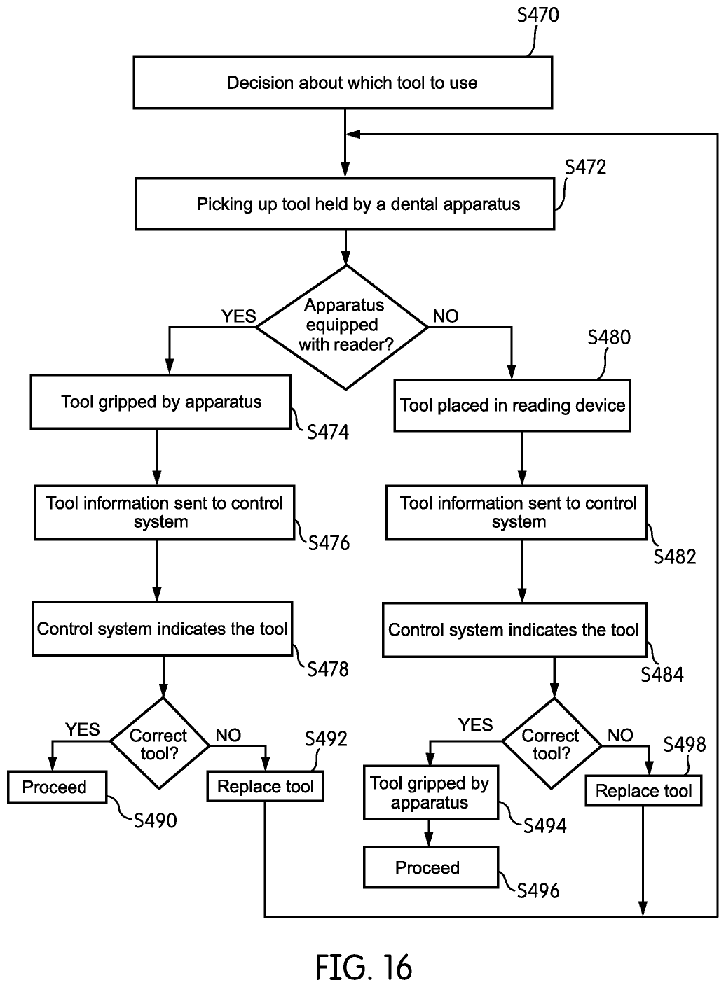

As shown in FIG. 16, a dentist may make a decision about which tool to use in a dental treatment procedure as shown in Step S470 of FIG. 16. After picking up the dental tool, Step S472, the dentist checks if the dental apparatus 104 is equipped with a reader. In some cases, when a dental apparatus 104 is equipped with a reader such as an optical reader 204, the dental tool may be inserted into the dental apparatus 104 as shown in Step S474. The dental apparatus may include a light source 202 and an optical reader 204 that, upon operation, transfer to the control system 1302 the distinct data of the dental tool 102 as in Step S476. The control system 1302 indicates the dental tool 102 in Step S478 and if found to the correct tool by the control system 1302, the dental treatment proceeds, Step S490. However if found to be the wrong tool, the tool should be replaced and the process is repeated with the new tool, Step S492.

In other cases, when using a dental tool 102 with a common dental apparatus as known in the art, i.e., a dental apparatus that is not provided with means to operate the transponder and read the data therefrom (not equipped with a reader), prior to inserting the dental tool 102 into the dental apparatus, the dental tool 102 may be inserted into the reading device 1004, as in Step S480, that is connected to the control system 1302. The reading device 1004 may include, as described above, a light source 202 and an optical reader 204 that, upon operation, transfer to the control system 1302 the distinct data of the dental tool 102 in Step 482, similar to the manner described above. The control system 1302 may indicate the dental tool 102 in Step 484 and upon identifying that the dental tool 102 is the correct tool, the dental tool 102 is gripped by the dental apparatus 104 in Step S494 in order to proceed with dental treatment, Step S496. However if the dental tool 102 is the wrong tool, the tool is replaced in Step 9498 and the process repeated. This process is schematically shown in FIG. 16.

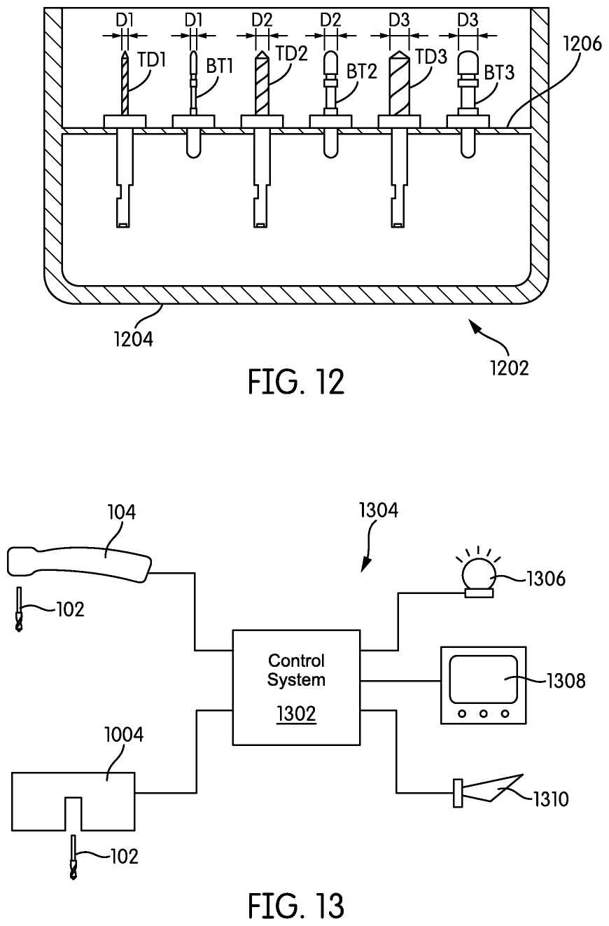

FIG. 12 shows a sample of a dental kit 1202 for demonstrating the use of the system 1304 according to the present disclosure. The dental kit 1202 may include a casing 1204 having a platform 1206 for receiving therein a variety of dental tools. The sample dental kit 1202 may include the following dental tools: (i) a first twist drill TD1 having a first diameter D1, (ii) a first body try-in BT1 having the same first diameter D1, (iii) a second twist drill TD2 having a second diameter D2 that is larger than the first diameter D1, (iv) a second body try-in BT2 having the same second diameter D2, (v) a third twist drill TD3 having a third diameter D3 that is larger than the second diameter D2, and, (vi) a third body try-in BT3 having the same third diameter D3. Any or all of these components may include transponders. Optionally or alternatively, a container for the kit may include a transponder. Optionally, the transponders may indicate a connection between parts of the kit, for example, a next tool to use or a setting suitable for a tool based on previous tool use. Optionally, the transponders may store an index and actual information may be stored in system 1302 and/or read over a network (e.g., an internet).

In order to make a hole having the third diameter D3 into a bone tissue, the following steps may be followed: (i) Gripping the first twist drill TD1 by a dental apparatus 104 and drilling a hole having a first diameter D1 optionally until the built-in stopper touches the bone tissue. Optionally, settings are provided to a drilling control system prior to actual drilling. Such setting may be optionally obtained by reading data off the transponder of TD1. Such setting may also be used for other tools, instead or in addition. (ii) Gripping the first body try-in BT1 by hand and inserting it into the drilled hole in order to verify that the diameter of the hole is the first diameter D1. (iii) Gripping the second twist drill TD2 by the dental apparatus 104 and drilling a hole having a second diameter D2 until the built-in stopper touches the bone tissue. (iv) Gripping the second body try-in BT2 by hand and inserting it into the drilled hole in order to verify that the diameter of the hole is the second diameter D2. (v) Gripping the third twist drill TD3 by the dental apparatus 104 and drilling a hole having a third diameter D3 until the built-in stopper touches the bone tissue. (vi) Gripping the third body try-in BT3 by hand and inserting it into the drilled hole in order to verify that the diameter of the hole is the third diameter D3.

One or more of the dental tools, e.g. the twist drills and the body try-ins, may be provided with a transponder 504 having distinct data of the dental tool. Thus, prior to using the dental tool it may be desirable to read the data of the dental tool and provide acknowledgement if it is the correct tool according to procedures pre-set at the control system 1302.

Since the twist drills are gripped by the dental apparatus 104, the data from the transponder 504 may be transferred to the control system 1302 through the light source 202 and the optical reader 204 that may be located within the dental apparatus 104. However, since the body try-ins may not be gripped by the dental apparatus 104, the data from the respective transponders may optionally be obtained by positioning each body try-in opposite or into the reading device 1004.

Thus, if the control system 1302 detects that the correct tool is used according to pre-set procedures, it may provide a first indicia such as a visual approval by, e.g., turning on a green light or an “OK” phrase on the monitor screen 1308, and/or producing an audio approval, like a short beep sound. If the control system 1302 detects that a wrong tool is about to be used, e.g., using a drill of a diameter larger or smaller than necessary, then, the control system 1302 may produce a second indicia such as a visual alarm like turning on a red light and a “WRONG” phrase on the monitor screen 1308, and/or making an alarm sound.

### Computer System

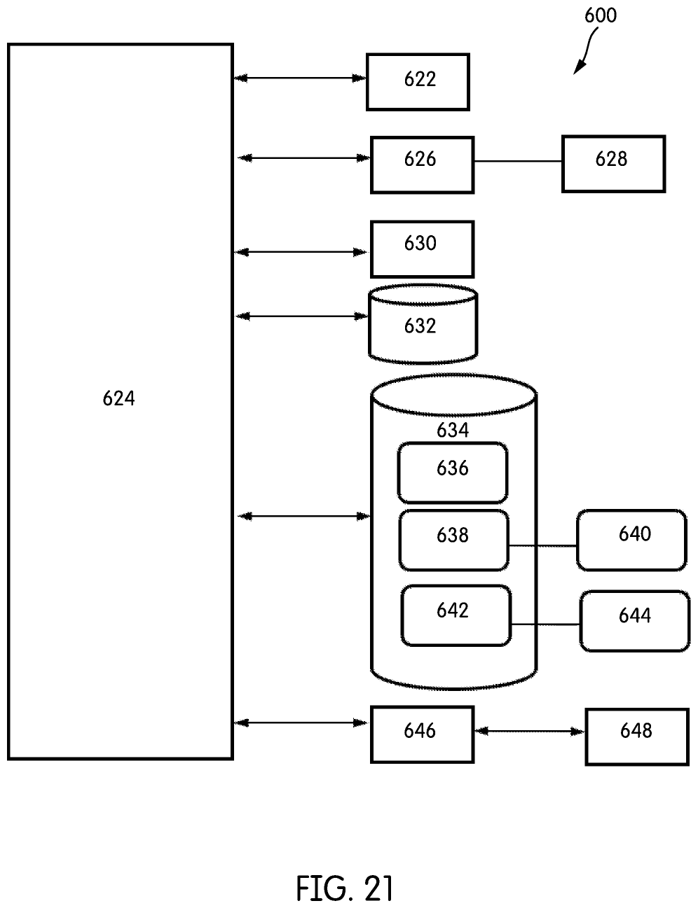

Having described a system 1304 for identifying a dental tool, reference will now be made to FIG. 21, which shows a block diagram of a computer system 600 that may be employed in accordance with at least some of the example embodiments herein.

Although various embodiments are described herein in terms of this exemplary computer system 600, after reading this description, it will become apparent to a person skilled in the relevant art(s) how to implement the disclosure using other computer systems and/or architectures.

In one example embodiment herein, at least some components of the computer system 600 may form or be may be included in the control system 1302 of FIG. 13. The computer system 600 includes at least one computer processor 622. The computer processor 622 may include, for example, a central processing unit, a multiple processing unit, or the like. The processor 622 may be connected to a communication infrastructure 624 (e.g., a communications bus, or a network).

The computer system 600 may also include a display interface (or other output interface) 626 that forwards data from the communication infrastructure 624 (or from a frame buffer (not shown)) for display on a display unit 628 (which, in one example embodiment, may form or be included in the monitor screen 1308 of FIG. 13).

The computer system 600 may also include an input unit 630 that may be used by a user of the computer system 600 to send information to the computer processor 622. The input unit 630 may include a keyboard device and/or a mouse device or other input device. In another example, the display unit 628, the input unit 630, and the computer processor 622 may collectively form a user interface. In yet another embodiment, the input unit 630 may be a switch (not shown) located on the dental apparatus. The processor 622 may send and receive data from the optical reader 204 of the dental apparatus 104 or the optical reader 204 of the reading device 1004. The processor 622 may also control the light source 202 of the dental apparatus 104 or the light source 202 of the reading device 1004. Moreover, the processor 622 communicates with visual accessories like the warning light 1306, monitor screen 1308, and speaker 1310 through the communication bus 624. In an embodiment, a motor unit attached to the dental apparatus may be constructed to house the computer system 600.

In yet another embodiment that may include a touch screen, the input unit 630 and the display unit 628 may be combined, or may represent a same user interface. In such an embodiment, a user touching the display unit 628 may cause corresponding signals to be sent from the display unit 628 to the display interface 626, which may forward those signals to a processor such as processor 622. Processor 622 may be configured to perform part (or all) of any of the procedures described herein. For example, one or more steps of the procedures illustrated in FIGS. 11, 14, 15 and 16 may be stored on a non-transitory storage device in the form of computer-readable program instructions. To execute a procedure, the processor 622 loads the appropriate instructions, as stored on storage device, into memory 632, and then executes the loaded instructions.

Moreover, the computer system 600 may include a main memory 632, which may be a random access memory (“RAM”), and also may include a secondary memory 634. The secondary memory 634 may include, for example, a hard disk drive 636 and/or a removable-storage drive 638. The removable-storage drive 638 reads from and/or writes to a removable storage unit 640 in a well-known manner. The removable storage unit 640 may be, for example, a floppy disk, a magnetic tape, an optical disk, a flash memory device, and the like, which is written to and read from by the removable-storage drive 638. The removable storage unit 640 may include a non-transitory computer-readable storage medium storing computer-executable software instructions and/or data.

In further alternative embodiments, the secondary memory 634 may include other computer-readable media storing computer-executable programs or other instructions to be loaded into the computer system 600. Such devices may include a removable storage unit 644 and an interface 642; a removable memory chip (e.g., an erasable programmable read-only memory (“EPROM”) or a programmable read-only memory (“PROM”)) and an associated memory socket; and other removable storage units 644 and interfaces 642 that allow software and data to be transferred from the removable storage unit 644 to other parts of the computer system 600.

The computer system 600 also may include a communications interface 646 that enables software and data to be transferred between the computer system 600 and external devices. Such an interface may include a modem, a network interface (e.g., an Ethernet card or an IEEE 802.11 wireless LAN interface), a communications port (e.g., a Universal Serial Bus (“USB”) port or a FireWire® port), a Personal Computer Memory Card International Association (“PCMCIA”) interface, and the like. Software and data transferred via the communications interface 646 may be in the form of signals, which may be electronic, electromagnetic, optical or another type of signal that is capable of being transmitted and/or received by the communications interface 646. Signals are provided to the communications interface 646 via a communications path 648 (e.g., a channel). The communications path 648 carries signals and may be implemented using wire or cable, fiber optics, a telephone line, a cellular link, a radio-frequency (“RF”) link, or the like. The communications interface 646 may be used to transfer software or data or other information between the computer system 600 and a remote server or cloud-based storage (not shown).

One or more computer programs or computer control logic may be stored in the main memory 632 and/or the secondary memory 634. The computer programs may also be received via the communications interface 646. The computer programs include computer-executable instructions which, when executed by the computer processor 622, cause the computer system 600 to perform some of the processes described herein and shown in FIGS. 11 and 14-16.

In another embodiment, the software may be stored in a non-transitory computer-readable storage medium and loaded into the main memory 632 and/or the secondary memory 634 of the computer system 600 using the removable-storage drive 638, the hard disk drive 636, and/or the communications interface 646. Control logic (software), when executed by the processor 622, causes the computer system 600, and dental system 1304, to perform the processes described herein.

Lastly, in another example embodiment hardware components such as ASICs, FPGAs, and the like, may be used to carry out the functionality described herein. Implementation of such a hardware arrangement so as to perform the functions described herein will be apparent to persons skilled in the relevant art(s) in view of this description.

It is expected that during the life of a patent maturing from this application many relevant energizing ways will be developed, including, but not limiting, optical, magnetic, or radio; the scope of the terms “energizing” and “energy source” is intended to include all such new technologies a priori.

As used herein with reference to quantity or value, the term “about” means “within ±50% of”. The terms “comprises”, “comprising”, “includes”, “including”, “has”, “having” and their conjugates mean “including but not limited to”. The term “consisting of” means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers therebetween. Unless otherwise indicated, numbers used herein and any number ranges based thereon are approximations within the accuracy of reasonable measurement and rounding errors as understood by persons skilled in the art.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

What is claimed is:

1. A dental tool configured for being held by a dental apparatus, the dental tool having at least one material-removing edge in a front portion thereof and a gripping portion in a rear portion thereof, wherein
the dental tool comprises a transponder.

2. The dental tool according to claim 1, wherein
the transponder is attached at the rear portion of the dental tool.

3. The dental tool according to claim 2, wherein
the rear portion is generally cylindrical around a longitudinal axis and comprising a cylindrical envelope and a substantially planar end face that is substantially perpendicular to the longitudinal axis, and wherein
the transponder is attached at the end face of the rear portion.

4. The dental tool according to claim 2, wherein
the transponder is attached to a cylindrical envelope of the rear portion.

5. The dental tool according to claim 1, wherein
the dental tool is provided with a peripheral ring positioned between the front portion and the rear portion, and wherein
the transponder is located on the peripheral ring.

6. The dental tool according to claim 5, wherein
the transponder is located within the peripheral ring, and wherein
the transponder is an RF transponder.

7. The dental tool according to claim 1, wherein
The transponder is positioned within a recess formed in the dental tool.

8. The dental tool according to claim 1, wherein
the transponder is covered with a protective substance.

9. The dental tool according to claim 8, wherein
the protective substance is epoxy.

10. The dental tool according to claim 1, wherein
the transponder is an optical transponder.

11. The dental tool according to claim 1, wherein
the transponder comprises distinct data of the dental tool.

12. The dental tool according to claim 1, wherein
the transponder includes a memory that has an identification of the dental tool.

13. The dental tool according to claim 1, wherein
the dental tool is a rotary tool.

14. A dental apparatus for holding a dental tool having a transponder, the dental apparatus comprising a head portion having a gripping portion for gripping the dental tool, wherein the dental apparatus includes an energy source for energizing the transponder and an energy receiver for receiving a signal from the transponder.

15. The dental apparatus according to claim 14, wherein
the energy source and the energy receiver are optical.

16. The dental apparatus according to claim 14, wherein
the energy source is a light source and the energy receiver is an optical receiver.

17. The dental apparatus according to claim 14, wherein
the energy source and the energy receiver are positioned at the head portion of the dental apparatus.

18. The dental apparatus according to claim 14, wherein
in a gripped position of the dental tool, the energy source and the energy receiver are distanced from the transponder.

19. The dental apparatus according to claim 14, wherein
the dental tool is a rotary tool,
the dental apparatus having propulsion means for rotating the dental tool, and wherein
in an operative position of the dental tool, the propulsion means are distanced from the transponder.

20. A system for identifying the dental tool of claim 1, the system comprises an energy source for energizing the transponder and an energy receiver for receiving a signal from the transponder,
the transponder is attached to the dental tool and includes distinct data of the dental tool, and wherein
when the energy source energizes the transponder and receives a signal from the transponder, the system responds to the distinct data of the dental tool.

21. The system according to claim 20, wherein
the system further comprises procedures that assign a specific dental tool for a specific dentistry operation, and wherein upon receiving the data from the transponder, the system alerts if the dental tool comprising the transponder is a wrong dental tool according to the procedures.

22. The system according to claim 20, wherein
the system further comprises procedures that assign a given quantity of working-hours for any dental tool for specific dentistry operations, and wherein
upon receiving the data from the transponder, the system alerts if the dental tool exceeded the assigned working-hours according to the procedures.

23. A method for identifying the dental tool of claim 1, the method comprising the steps of:
a—providing the dental tool,
b—providing an energy source for energizing the transponder and an energy receiver for receiving a signal from the transponder,
c—providing a system that upon energizing the transponder and receiving a signal therefrom, modifies, indicates and/or uses the distinct data of the dental tool.

24. The method according to claim 23, wherein
the energy source and the energy receiver are located within the dental apparatus.

25. The method according to claim 23, wherein
the system includes procedures that assign a specific dental tool for a specific dentistry operation, and wherein
upon receiving the data from the transponder, the system alerts if the dental tool comprising the transponder is a wrong dental tool according to the procedures.

26. The method according to claim 23, wherein
the system includes procedures that assign a given quantity of working-hours for any dental tool for specific dentistry operations, and wherein
upon receiving the data from the transponder, the system alerts if the dental tool exceeded the assigned working-hours according to the procedures.

27. The method according to claim 23, wherein
the system includes procedures that assign a specific dental tool for a specific dentistry operation, and wherein
upon receiving the data from the transponder, the system modifies or generates an indication of a desired modification in tool settings according to the procedures.
